(19) United States
(12) Patent Application Publication
(10) Pub. No.: US 2019/0230918 A1
(43) Pub. Date: Aug. 1, 2019

(54) UMBILICAL CORD, UMBILICAL CORD BLOOD AND PLACENTA COLLECTION KIT

(71) Applicant: CENTURY BIOSTRENGTH BEIJING PTY LTD., Beijing (CN)

(72) Inventors: Yulin CAO, Beijing (CN); Xiayun LI, Beijing (CN); Zhihui BAI, Beijing (CN); Shihong LIU, Beijing (CN); Chengqian LU, Beijing (CN)

(73) Assignee: CENTURY BIOSTRENGTH BEIJING Pty Ltd., Beijing (CN)

(21) Appl. No.: 16/320,381

(22) PCT Filed: Aug. 11, 2016
(86) PCT No.: PCT/CN16/94677

§ 371 Date: Jan. 24, 2019

(30) Foreign Application Priority Data
Aug. 1, 2016 (CN) 2016106220165

(51) Int. Cl. A01N 1/02; A61J 1/16

(52) U.S. Cl. CPC A01N 1/0252; A61J 1/165; A61J 2205/10; A61J 2200/72; A01N 1/0215

(57) ABSTRACT

The kit for collection of umbilical cord, umbilical cord blood and placenta includes a collection case and a case cover hinged with the collection case. A tool box, a refrigeration box and a freezing box are arranged in the collection case. A liner plate is arranged in the tool box and provided with an accommodating trough, at least three storage troughs and several test tube troughs. An umbilical cord collection box, a placenta collection box and a blood collection bag are respectively arranged in the three storage troughs. A reagent bottle for containing a cell protection solution is arranged in the refrigeration box. Several ice bags are arranged in the freezing box.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of medical devices, particularly to a kit for collection of umbilical cord, umbilical cord blood and placenta.

### 2. Description of Related Art Including Information Disclosed Under 37 CFR 1.97 and 37 CFR 1.98

In recent years, the upsurge of preservation of placenta, umbilical cord and umbilical cord blood has increased year by year, because umbilical cord and placenta contain a large number of mesenchymal stem cells having the advantages of multi-directional differentiation potential, hematopoiesis support, promotion of stem cell implantation, immune regulation and self-renewing; umbilical cord blood contains abundant primitive hematopoietic stem cells used for supporting bone marrow reconstruction to make the receptor obtain a long-term hematopoiesis function. Therefore, it is found through study that umbilical cord blood can be used to treat aplastic anemia, leukemia and other disease, so that more and more people begin to collect umbilical cord, cord blood and placenta for future use.

At present, there is no uniform standard for containing devices for collecting human umbilical cord, umbilical cord blood and placenta, especially, there is no collection box for collecting and storing umbilical cord blood, umbilical cord and placenta simultaneously. In general, umbilical cord blood, umbilical cord and placenta are respectively placed in different collection boxes for storage, causing great inconvenience and trouble to users and keepers. The existing collection appliances for umbilical cord blood, umbilical cord and placenta are different, and the most common manner is disposable plastic package. Such collection manner is extremely inconvenient, and it is difficult to guarantee that the plastic packaging is not damaged during transportation, causing great hidden trouble to the safety and accuracy of collection of umbilical cord blood, umbilical cord and placenta.

### BRIEF SUMMARY OF THE INVENTION

The present invention starts from this observation and the need to monitor a person's activity, in order to detect a change in his behavior that would correspond to a danger to himself, then no longer requiring at-home monitoring, but placing him in a supportive environment, or hospitalizing him.

To solve the problems that the existing collection box has a complicated structure, the built-in tools are not clear at a glance, so that it is very inconvenient for doctors and nurses unfamiliar with the collection box to use them, what's more, there is no refrigerating effect in the box body, so that the collection box is not suitable for storing umbilical cord blood, umbilical cord and placenta for a long time, and is inconvenient to transport, the present invention provides a kit for collection of umbilical cord, umbilical cord blood and placenta.

The present invention has the following specific technical solution:

The present invention provides a kit for collection of umbilical cord, umbilical cord blood and placenta, comprising: a collection case and a case cover hinged with the collection case, wherein a tool box, a freezing box and a refrigeration box are arranged in the collection case from top to bottom in sequence, and both the refrigeration box and the freezing box are slidably connected with the collection case; a liner plate is arranged in the tool box, the liner plate is provided with an accommodating trough, three storage troughs and several test tube troughs, at least three vacuum blood collection tubes are arranged in the accommodating trough, and a umbilical cord collection box, a placenta collection box and a blood collection bag are respectively arranged in the three storage troughs; a reagent bottle for containing a cell protection solution is arranged in the refrigeration box; and several ice bags are arranged in the freezing box.

The kit provided by the present invention can be used to collect umbilical cord, umbilical cord blood and placenta simultaneously, and the collection case can be used to store the collected umbilical cord umbilical cord blood placenta within short time, thereby facilitating transportation of umbilical cord, umbilical cord blood and placenta.

Further, a rotating frame is arranged in the refrigeration box, the rotating frame comprising a bottom plate, a storage box and a rotating drum fixed onto the bottom plate, wherein the middle of the storage box is provided with a through hole, the storage box is sleeved on the rotating drum through the through hole, the storage box is internally divided into a plurality of sub boxes by baffle plates, and the reagent bottle is placed in one of the sub boxes; the rotating drum is of a hollow structure, the ice bags are arranged in the rotating drum, and the side wall of the rotating drum is provided with several through holes. In addition to being used to store the cell protection solution, the refrigeration box is also used to store the collected umbilical cord, umbilical cord blood and placenta within short time. The storage box is divided into a plurality of sub boxes by baffle plates, the umbilical cord collection box, the placenta collection box and the blood collection bag are respectively placed in different sub boxes for storage, so that transportation is convenient, thereby preventing cross contamination, and increasing the safety of transportation and storage of umbilical cord, umbilical cord blood and placenta.

To provide an appropriate environment for cell collection, to prevent the activity of cells from declining during storage, in this technical solution, further, the inner wall of the refrigeration box is uniformly provided with several grooves for placing the ice bags. When ice bags are placed in the grooves, the refrigeration box can maintain a temperature of 4° C., thereby being suitable for storing the collected umbilical cord, umbilical cord blood and placenta.

To strictly monitor the temperature in the refrigeration box, this technical solution further defines that the kit also comprises a temperature control device, the temperature control device including a controller, an alarm, a display screen and a temperature sensor arranged in the refrigeration box, wherein the controller, the alarm and the display screen are all arranged on the case cover, and the alarm, the display screen and the temperature sensor are all connected with the controller.

After collecting tissue cells, the umbilical cord collection box and the placenta collection box are required to be vertically placed. Thus, to prevent the box body from falling which may affect the activity of cells, the present invention further defines that each of the umbilical cord collection box and the placenta collection box comprises a box body and a box cover adapted to the box body, wherein a magnet is arranged at the bottom of the box body, and a magnetic object attracted to the magnet is arranged at the inner bottom of the sub box, the magnetic object being a magnet or a metal block; and the box body is provided with a bar code slot. The bar code slot can be used to paste bar codes, to prevent collection boxes from becoming confused and indistinguishable.

Further, a containing box is arranged at one side of the collection case, and record specifications, collection cards and bar codes are placed in the containing box.

Further, the liner plate is made of elastic material, the elastic material including components of the following part by weight: 30-45 parts by weight of basalt fiber, 10-25 parts by weight of aliphatic petroleum resin, 5-18 parts by weight of stannous octoate, 20-25 parts by weight of sodium tripolyphosphate and 10-15 parts by weight of C-12 alcohol ester. The elastic material formed by mixing basalt fiber, aliphatic petroleum resin, stannous octoate, sodium tripolyphosphate and C-12 alcohol ester not only has good flexibility but also has certain tenacity, is not difficult to be damaged, and can play a role of mitigating extrusion when being extruded, to protect test tubes, blood collection tubes or other devices.

Further, the cell protection solution in the reagent bottle is mainly formed by dissolving mycoplasma inhibitor and aminoglycoside antibiotics with a MEM-α medium aqueous solution, wherein each mL of the MEM-α medium aqueous solution dissolves 10-30 mg of the mycoplasma inhibitor and 180-240 U of the aminoglycoside antibiotics respectively, and the concentration of the MEM-α medium aqueous solution is 10-15 mg/mL; preferably, the aminoglycoside antibiotics is one or more of gentamicin, kanamycin, amikacin and tobramycin, and most preferably, the aminoglycoside antibiotics is formed by gentamicin and kanamycin in accordance with the proportion of parts by weight of 5:2.

By dissolving mycoplasma inhibitor and gentamicin in the MEM-α medium aqueous solution, the protection solution provided the present invention provides an appropriate storage environment for placental stem cells and mesenchymal stem cells. It is proved through a large number of experiments that the protection solution formed by cooperatively dissolving the two ingredients in the MEM-α medium aqueous solution can simulate a human environment, is more suitable for storing placental stem cells and mesenchymal stem cells, plays a role of protecting the activity of cells during transportation, prolongs transportation and storage time, prevents apoptosis of in-vitro cells during transportation and storage, and provides effective a basis for later storage of placenta or umbilical cord cells.

Further, the mycoplasma inhibitor includes components of the following part by weight: 20-40 parts by weight of kitasamycin, 10-30 parts by weight of lymecycline and 20-50 parts by weight of gemifioxacin; preferably, the mycoplasma inhibitor also includes components of the following part by weight: 5-10 parts by weight of curcuma zedoaria extract, 4-8 parts by weight of houttuynia cordata extract and 3-6 parts by weight of rhizoma smilacis glabrae extract. The mycoplasma inhibitor including kitasamycin, lymecycline and gemifioxacin can effectively inhibit and kill mycoplasma in the protection solution, has short action period, and has no influence on preservation and metabolism of placenta or umbilical cord cells. Moreover, the treated cell surfaces are smooth, placenta or umbilical cord cells may not be re-infected by mycoplasma easily during transportation and late storage, thereby providing a safe living environment for cell storage, and providing protection effect for transportation of placenta or umbilical cord.

Preferably, the present invention further provides that curcuma zedoaria extract, houttuynia cordata extract and rhizoma smilacis glabrae extract are added into the mycoplasma inhibitor. These three Chinese herbal medicinal ingredients can form the mycoplasma inhibitor through medicinal ingredients of integrated Chinese and Western medicine on the basis of the original Western medicine ingredients, which can effectively inhibit and kill mycoplasma in the protection solution, has short action period, has strong protection effect on cells, and prevents cell infection.

Further, the protection solution also contains lactobionic acid, blood albumin, sodium gluconate and glucosamine, wherein each mL of the MEM-α medium aqueous solution dissolves 5-8 mg of the lactobionic acid, 2-4 mg of the blood albumin, 5-8 mg of the sodium gluconate and 4-6 mg of the glucosamine. By adding lactobionic acid, blood albumin, sodium gluconate and glucosamine into the protection solution provided by the present invention, some nutritional ingredients can be provided for cells, and meanwhile, cell immunity can be increased, cell infection can be prevented, cell apoptosis can be inhibited, and the survival rate of cells can be increased.

The present invention has the following advantageous effects: the kit for collection provided by the present invention has a simple structure, and the built-in collection tools are complete and are clearly placed, so that doctors and nurses can use them conveniently; in addition, the kit can be used to collect umbilical cord, umbilical cord blood and placenta simultaneously, and can be used to preserve and transport the collected umbilical cord blood and placenta; and an appropriate environment can be provided for transportation and preservation of tissue because the kit comprises a refrigeration box, thereby increasing the safety of collection and transportation of umbilical cord, umbilical cord blood and placenta.

### BRIEF DESCRIPTION OF THE SEVERAL VIEWS OF THE DRAWINGS

FIG. 1 is a structural schematic view of the kit for collection of umbilical cord, umbilical cord blood and placenta of embodiment 1.

FIG. 2 is a structural schematic view of the kit for collection of umbilical cord, umbilical cord blood and placenta of embodiment 2.

FIG. 3 is a structural schematic view of a rotating frame in the kit for collection of umbilical cord, umbilical cord blood and placenta of embodiment 2.

FIG. 4 is a structural schematic view of an umbilical cord collection box in the kit for collection of umbilical cord, umbilical cord blood and placenta of embodiment 2.

FIG. 5 is a sectional view of a rotating frame in the kit for collection of umbilical cord, umbilical cord blood and placenta of embodiment 2.

In the drawings: 1. collection case; 2. case cover; 3. tool box; 4. refrigeration box; 5. freezing box; 6. liner plate; 7. accommodating trough; 8. storage trough; 9. test tube trough; 10. vacuum blood collection tube; 11. umbilical cord collection box; 12. placenta collection box; 13. blood collection bag; 14. reagent bottle; 15. ice bag; 16. bottom plate; 17. storage box; 18. rotating drum; 19. sub box; 20. groove; 21. controller; 22. alarm; 23. display screen; 24. temperature sensor; 25. box body; 26. box cover; 27. magnet; 28. magnetic object; 29. bar code slot; 30. containing box.

### DETAILED DESCRIPTION OF THE INVENTION

The present invention relates to a system for monitoring a person 1 within at least one room 2.

The present invention is further described in combination with the figures and the following embodiments.

### Embodiment 1

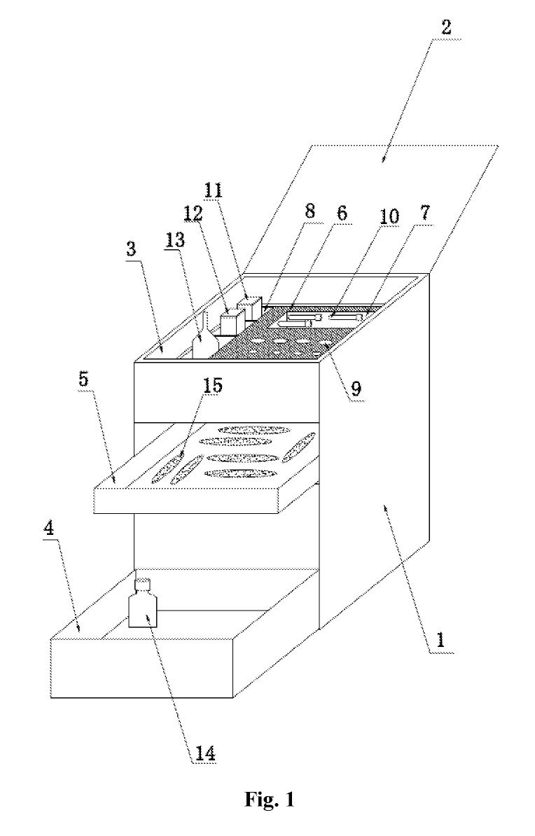

As shown in FIG. 1, embodiment 1 of the present invention provides a kit for collection of umbilical cord, umbilical cord blood and placenta, comprising: a collection case 1 and a case cover 2 hinged with the collection case 1, wherein a tool box 3, a freezing box 5 and a refrigeration box 4 are arranged in the collection case 1 from top to bottom in sequence, and both the refrigeration box 4 and the freezing box 5 are slidably connected with the collection case 1; the collection box 1 is used to collect umbilical cord, umbilical cord blood and placenta simultaneously, the tool box 3 is used to store tools required for collecting tissue, the refrigeration box 4 is used to store the collected umbilical cord, umbilical cord blood and placenta, and provide an appropriate temperature environment for tissue storage; and for the convenience of use, the refrigeration box 4 and the freezing box 5 are designed to be slidably connected with the collection box 1, it is similar to a drawer structure, and is convenient to use.

To make medical staff search tools more conveniently, and increase the tissue collection efficiency, this technical solution defines that a liner plate 6 is arranged in the tool box 3, the liner plate 6 is provided with an accommodating trough 7, at least three storage troughs 8 and several test tube troughs 9, at least three vacuum blood collection tubes 10 are arranged in the accommodating trough 7, and a umbilical cord collection box 11, a placenta collection box 12 and a blood collection bag 3 are respectively arranged in the three storage troughs 8; during collection, the vacuum blood collection tube 10 is used in combination with the blood collection bag 3, to increase the collection efficiency; both the vacuum blood collection tube 10 and the blood collection bag 3 are identical to the existing blood collection tube and blood collection bag 3; while in use, the vacuum blood collection tube 10 can be temporarily placed in the test tube trough 9; the reagent bottle 14 for containing a cell protection solution is placed in the refrigeration box 4; and several ice bags 15 are arranged in the freezing box 5. The protection solution required for collecting tissue is placed in the reagent bottle 14 to prevent apoptosis of cells within short time. The ice bags 15 can be frozen in the freezing box 5, and after tissue is collected, the frozen ice bags 15 are placed in the refrigeration box 4, to provide an appropriate temperature environment for the refrigeration box 4, thereby facilitating transportation of umbilical cord, umbilical cord blood, placenta and other tissue.

### Embodiment 2

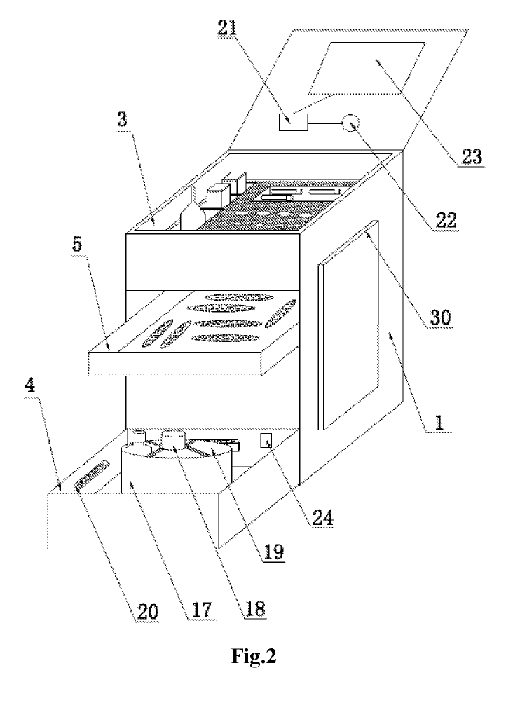

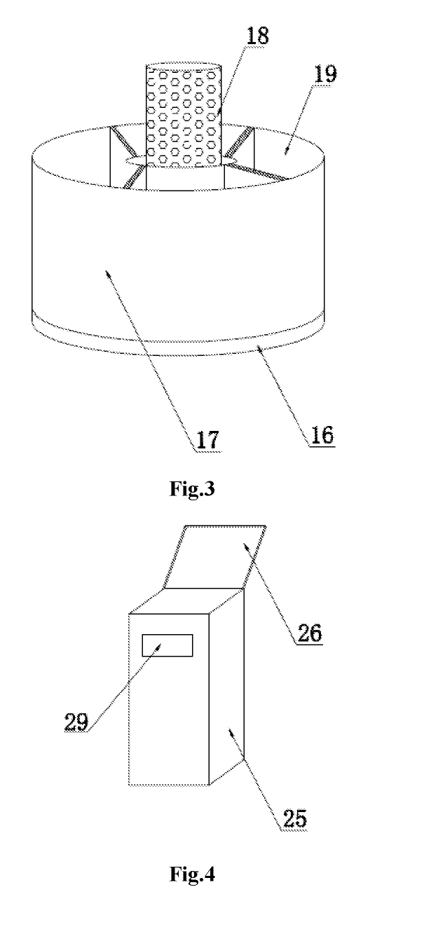

As shown in FIG. 2 or FIG. 3, this embodiment 2 further defines on the basis of embodiment 1 that a rotating frame is arranged in the refrigeration box 4, the rotating frame is used for placing the umbilical cord collection box 11, the placenta collection box 12 and the blood collection bag 3 after collecting tissue, the rotating frame comprising a bottom plate 16, a storage box 17 and a rotating drum 18 fixed onto the bottom plate 16, wherein the middle of the storage box 17 is provided with a through hole, the storage box 17 is sleeved on the rotating drum 18 through the through hole, and the storage box 17 is rotated about the rotating drum 18, to conveniently take out or place the collection boxes. To prevent tissue from falling during transportation which may cause tissue cell to lose activity and cause cross infection between cells, this technical solution defines that the storage box 17 is internally divided into a plurality of sub boxes 19 by baffle plates, the reagent bottle 14 is placed in one of the sub boxes 19, and the umbilical cord collection box 11, the placenta collection box 12 and the blood collection bag 3 are respectively placed in different sub boxes 19.

To give cells an appropriate living environment, this technical solution defines that the rotating drum 18 is of a hollow structure, the ice bags 15 are arranged in the rotating drum 18, and the side wall of the rotating drum 18 is provided with several through holes. The arrangement of the ice bags 15 in the rotating drum 18 can increase the refrigeration effect, preventing cells from losing activity during transportation.

As shown in FIG. 2, further, to increase the refrigeration effect, this technical solution defines that the inner wall of the refrigeration box 4 is uniformly provided with several grooves 20 for placing the ice bags 15.

As shown in FIG. 2, to strictly monitor the temperature in the refrigeration box 4, this technical solution further defines that the kit also comprises a temperature control device, the temperature control device including a controller 21, an alarm 22, a display screen 23 and a temperature sensor 24 arranged in the refrigeration box 4, wherein the controller 21, the alarm 22 and the display screen 23 are all arranged on the case cover 2, and the alarm 22, the display screen 23 and the temperature sensor 24 are all connected with the controller 21. When the alarm 22 gives an alarm, there is a need to replace the ice bags 15 in the refrigeration box 4 in time, so that the refrigeration box 4 always maintains an appropriate temperature.

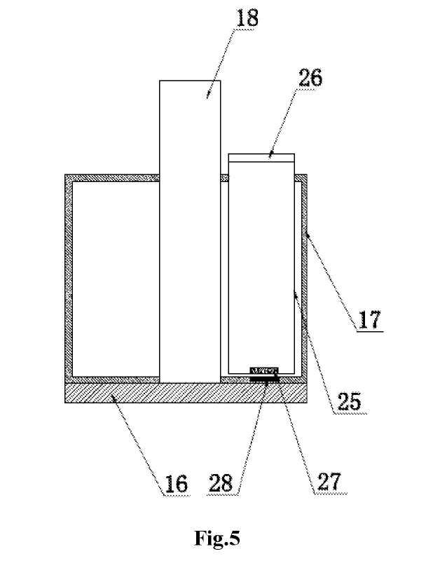

As shown in FIG. 4 and FIG. 5, for the convenience of transportation, this technical solution defines that each of the umbilical cord collection box 11 and the placenta collection box 12 comprises a box body 25 and a box cover 26 adapted to the box body 25, wherein a magnet 27 is arranged at the bottom of the box body 25, and a magnetic object 28 attracted to the magnet 27 is arranged at the inner bottom of the sub box 19, the magnetic object 28 being a magnet 27 or a metal block; and the box body 25 is provided with a bar code slot 29. To prevent the box body 25 from falling during transportation which may cause tissue cells to lose activity due to shock, this technical solution defines that a magnet 27 is arranged at the bottom of the box body 25. The magnet 27 can attract the magnetic object 28 at the bottom of the sub box 19, so that the box body 25 is kept vertical without falling, thereby increasing the safety of transportation of tissue cells.

As shown in FIG. 2, it should be noted that a containing box 30 is arranged at one side of the collection case 1, and record specifications, collection cards and bar codes are placed in the containing box 30. The contain box 30 can be used to contain instruction manuals or record specifications, the collection cards can be used to record donor data and collection information in detail, and meanwhile, bar codes corresponding to the collection boxes can be pasted on the collection cards, to prevent collection errors caused by taking collection boxes by mistake in case of confusion.

The bar codes are internally provided with serial number information. After collection ends, the bar codes are respectively taken out and then pasted on the collection boxes or collection cards to facilitate later use.

While in use, the present invention comprises the following steps: 1. opening a sample collection kit before collection, taking out the placenta collection box 12, the umbilical cord collection box 11, the blood collecting bag 3 and the cell protection solution for use; 2. respectively storing the collected umbilical cord, placenta and umbilical cord blood in the umbilical cord collection box 11, the placenta collection box 12 and the blood collection bag 3; 3. pouring the cell protection solution into the collection box, preferably, immersing umbilical cord or placenta; 4. tightening the box cover 26 of the placenta or umbilical cord collection box 11; 5. pasting a bar code on the placenta or umbilical cord collection box 11; 6. temporarily storing: placing the placenta collection box 12, the umbilical cord collection box 11 and the blood collection bag 3 on the rotating frame of the refrigeration box 4 with the temperature of 4° C., guaranteeing that the box cover 26 of the collection box is tightened and the collection box is vertical and stable, placing the frozen ice bags 15 in the grooves 20 in the refrigeration box 4, and keeping the temperature in the refrigeration box 4 to be 4° C.; 7. pasting bar codes on collection cards, filling in donor data and collection information in detail, and strictly controlling the temperature in the refrigeration box 4 by the temperature control device finally, thereby providing an appropriate living environment for tissue cells.

### Embodiment 3

Embodiment 3 of the present invention further defines on the basis of embodiment 1 that the liner plate 6 is made of elastic material, the elastic material including components of the following part by weight: 30 parts by weight of basalt fiber, 10 parts by weight of aliphatic petroleum resin, 5 parts by weight of stannous octoate, 20 parts by weight of sodium tripolyphosphate and 10 parts by weight of C-12 alcohol ester.

### Embodiment 4

Embodiment 4 of the present invention further defines on the basis of embodiment 1 that the liner plate 6 is made of elastic material, the elastic material including components of the following part by weight: 45 parts by weight of basalt fiber, 25 parts by weight of aliphatic petroleum resin, 18 parts by weight of stannous octoate, 25 parts by weight of sodium tripolyphosphate and 15 parts by weight of C-12 alcohol ester.

### Embodiment 5

The cell protection solution in the reagent bottle 14 mentioned in embodiment 1 is mainly formed by dissolving mycoplasma inhibitor and gentamicin with a MEM-α medium aqueous solution, wherein each mL of the MEM-α medium aqueous solution dissolves 10 mg of the mycoplasma inhibitor and 180 U of the gentamicin respectively, and the concentration of the MEM-α medium aqueous solution is 10 mg/mL.

### Embodiment 6

The cell protection solution in the reagent bottle 14 mentioned in embodiment 1 is mainly formed by dissolving mycoplasma inhibitor, gentamicin and kanamycin with a MEM-α medium aqueous solution, wherein each mL of the MEM-α medium aqueous solution dissolves 20 mg of the mycoplasma inhibitor, 150 U of the gentamicin and 60 U of the kanamycin respectively, and the concentration of the MEM-α medium aqueous solution is 12.5 mg/mL.

### Embodiment 7

The cell protection solution in the reagent bottle 14 mentioned in embodiment 1 is mainly formed by dissolving mycoplasma inhibitor, gentamicin, amikacin and tobramycin with a MEM-α medium aqueous solution, wherein each mL of the MEM-a medium aqueous solution dissolves 30 mg of the mycoplasma inhibitor, 80 U of the gentamicin, 80 U of the amikacin and 80 U of the tobramycin, and the concentration of the MEM-α medium aqueous solution is 15 mg/mL.

The mycoplasma inhibitor includes components of the following part by weight: 20 parts by weight of kitasamycin, 10 parts by weight of lymecycline and 20 parts by weight of gemifioxacin.

The present invention further provides a preparation method for a protection solution of placenta and umbilical cord cells, the preparation method comprising the following steps:

S1. Measuring a MEM-α medium aqueous solution with the concentration of 15 mg/mL, adding gentamicin, amikacin and tobramycin into the MEM-α medium aqueous solution, and stirring to make the gentamicin, amikacin and tobramycin be fully dissolved in the MEM-α medium aqueous solution, wherein each mL of the MEM-α medium aqueous solution dissolves 80 U of the gentamicin, 80 U of the amikacin and 80 U of the tobramycin; and

S2. Adding mycoplasma inhibitor into the MEM-α medium aqueous solution in which gentamicin, amikacin and tobramycin are dissolved in the step 1, and stirring to make the mycoplasma inhibitor be fully dissolved in the MEM-α medium aqueous solution, i.e. obtain the protection solution of placenta and umbilical cord cells, wherein each mL of the MEM-α medium aqueous solution dissolves 30 mg of the mycoplasma inhibitor.

The preparation method for the mycoplasma inhibitor comprises: directly mixing 20 parts of kitasamycin, 10 parts of lymecycline and 20 parts of gemifioxacin.

### Embodiment 8

The cell protection solution in the reagent bottle 14 mentioned in embodiment 1 is mainly formed by dissolving mycoplasma inhibitor, gentamicin, kanamycin and amikacin with a MEM-α medium aqueous solution, wherein each mL of the MEM-α medium aqueous solution dissolves 20 mg of the mycoplasma inhibitor, 70 U of the gentamicin, 70 U of the kanamycin and 70 U of the amikacin respectively, and the concentration of the MEM-α medium aqueous solution is 11 mg/mL.

The mycoplasma inhibitor includes components of the following part by weight: 30 parts by weight of kitasamycin, 20 parts by weight of lymecycline and 35 parts by weight of gemifioxacin.

The preparation method for the protection solution provided in this embodiment is the same as the method in embodiment 7.

The preparation method for the mycoplasma inhibitor comprises: directly mixing 30 parts by weight of kitasamycin, 20 parts by weight of lymecycline and 35 by weight parts of gemifioxacin.

### Embodiment 9

The cell protection solution in the reagent bottle 14 mentioned in embodiment 1 is mainly formed by dissolving mycoplasma inhibitor, gentamicin, kanamycin, amikacin and tobramycin with a MEM-α medium aqueous solution, wherein each mL of the MEM-α medium aqueous solution dissolves 10 mg of the mycoplasma inhibitor, 60 U of the gentamicin, 60 U of the kanamycin, 30 U of the amikacin and 30 U of the tobramycin respectively, and the concentration of the MEM-α medium aqueous solution is 12 mg/mL.

The mycoplasma inhibitor includes components of the following part by weight: 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

The preparation method for the protection solution provided in this embodiment is the same as the method in embodiment 7.

The preparation method for the mycoplasma inhibitor comprises: directly mixing 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

### Embodiment 10

The cell protection solution in the reagent bottle 14 mentioned in embodiment 1 is mainly formed by dissolving mycoplasma inhibitor, gentamicin, kanamycin, amikacin and tobramycin with a MEM-α medium aqueous solution, wherein each mL of the MEM-α medium aqueous solution dissolves 10 mg of the mycoplasma inhibitor, 60 U of the gentamicin, 60 U of the kanamycin, 30 U of the amikacin and 30 U of the tobramycin respectively, and the concentration of the MEM-α medium aqueous solution is 12 mg/mL.

The mycoplasma inhibitor includes components of the following part by weight: 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

The preparation method for the protection solution provided in this embodiment is the same as the method in embodiment 7.

The preparation method for the mycoplasma inhibitor comprises: directly mixing 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

### Embodiment 11

The cell protection solution in the reagent bottle 14 mentioned in embodiment 1 is mainly formed by dissolving mycoplasma inhibitor, gentamicin, hydroxyethyl starch and chitin with a MEM-α medium aqueous solution, wherein each mL of the MEM-α medium aqueous solution dissolves 10 mg of the mycoplasma inhibitor, 180 U of the gentamicin, 10 mg of the hydroxyethyl starch and 1 mg of the chitin respectively, and the concentration of the MEM-α medium aqueous solution is 10 mg/mL.

The mycoplasma inhibitor includes components of the following part by weight: 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

The preparation method for the protection solution provided by this embodiment comprises: respectively dissolving 10 mg of the mycoplasma inhibitor, 180 U of the gentamicin, 10 mg of the hydroxyethyl starch and 1 mg of the chitin in the MEM-α medium aqueous solution.

The preparation method for the mycoplasma inhibitor comprises: directly mixing 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

### Embodiment 12

The cell protection solution in the reagent bottle 14 mentioned in embodiment 1 is mainly formed by dissolving mycoplasma inhibitor, gentamicin, hydroxyethyl starch and chitin with a MEM-α medium aqueous solution, wherein each mL of the MEM-α medium aqueous solution dissolves 10 mg of the mycoplasma inhibitor, 180 U of the gentamicin, 8 mg of the hydroxyethyl starch and 3 mg of the chitin respectively, and the concentration of the MEM-α medium aqueous solution is 10 mg/mL.

The mycoplasma inhibitor includes components of the following part by weight: 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

The preparation method for the protection solution provided by this embodiment comprises: respectively dissolving 10 mg of the mycoplasma inhibitor, 180 U of the gentamicin, 8 mg of the hydroxyethyl starch and 3 mg of the chitin in the MEM-α medium aqueous solution.

The preparation method for the mycoplasma inhibitor comprises: directly mixing 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

### Embodiment 13

The cell protection solution in the reagent bottle 14 mentioned in embodiment 1 is mainly formed by dissolving mycoplasma inhibitor, gentamicin, hydroxyethyl starch, chitin, dextran and heparin sodium with a MEM-α medium aqueous solution, wherein each mL of the MEM-α medium aqueous solution dissolves 20 mg of the mycoplasma inhibitor, 210 U of the gentamicin, 9 mg of the hydroxyethyl starch, 5 mg of the chitin, 4 mg of the dextran and 1 mg of the heparin sodium respectively, and the concentration of the MEM-α medium aqueous solution is 10 mg/mL.

The mycoplasma inhibitor includes components of the following part by weight: 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

The preparation method for the protection solution provided by this embodiment comprises: respectively dissolving 20 mg of the mycoplasma inhibitor, 210 U of the gentamicin, 9 mg of the hydroxyethyl starch, 5 mg of the chitin, 4 mg of the dextran and 1 mg of the heparin sodium in the MEM-α medium aqueous solution.

The preparation method for the mycoplasma inhibitor comprises: directly mixing 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

### Embodiment 14

The cell protection solution in the reagent bottle 14 mentioned in embodiment 1 is mainly formed by dissolving mycoplasma inhibitor, gentamicin, hydroxyethyl starch, chitin, dextran, heparin sodium, sodium selenite and N-Acetyl-L-cysteine with a MEM-α medium aqueous solution, wherein each mL of the MEM-α medium aqueous solution dissolves 10 mg of the mycoplasma inhibitor, 180 U of the gentamicin, 8 mg of the hydroxyethyl starch, 3 mg of the chitin, 6 mg of the dextran, 3 mg of the heparin sodium, 0.4 mg of the sodium selenite and 0.1 mg of the N-Acetyl-L-cysteine respectively, and the concentration of the MEM-α medium aqueous solution is 10 mg/mL.

The mycoplasma inhibitor includes components of the following part by weight: 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

The preparation method for the protection solution provided by this embodiment comprises: respectively dissolving 10 mg of the mycoplasma inhibitor, 180 U of the gentamicin, 8 mg of the hydroxyethyl starch, 3 mg of the chitin, 6 mg of the dextran, 3 mg of the heparin sodium, 0.4 mg of the sodium selenite and 0.1 mg of the N-Acetyl-L-cysteine in the MEM-α medium aqueous solution.

The preparation method for the mycoplasma inhibitor comprises: directly mixing 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

### Embodiment 15

The cell protection solution in the reagent bottle 14 mentioned in embodiment 1 is mainly formed by dissolving mycoplasma inhibitor, gentamicin, hydroxyethyl starch, chitin, dextran, heparin sodium, sodium selenite, N-Acetyl-L-cysteine, lactobionic acid, blood albumin, sodium gluconate and glucosamine with a MEM-α medium aqueous solution, wherein each mL of the MEM-α medium aqueous solution dissolves 20 mg of the mycoplasma inhibitor, 210 U of the gentamicin, 9 mg of the hydroxyethyl starch, 1 mg of the chitin, 4 mg of the dextran, 1 mg of the heparin sodium, 0.6 mg of the sodium selenite, 0.3 mg of the N-Acetyl-L-cysteine, 5 mg of the lactobionic acid, 2 mg of the blood albumin, 5 mg of the sodium gluconate and 4 mg of the glucosamine respectively, and the concentration of the MEM-α medium aqueous solution is 10 mg/mL.

The mycoplasma inhibitor includes components of the following part by weight: 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

The preparation method for the protection solution provided by this embodiment comprises: respectively dissolving 20 mg of the mycoplasma inhibitor, 210 U of the gentamicin, 9 mg of the hydroxyethyl starch, 1 mg of the chitin, 4 mg of the dextran, 1 mg of the heparin sodium, 0.6 mg of the sodium selenite, 0.3 mg of the N-Acetyl-L-cysteine, 5 mg of the lactobionic acid, 2 mg of the blood albumin, 5 mg of the sodium gluconate and 4 mg of the glucosamine in the MEM-α medium aqueous solution.

The preparation method for the mycoplasma inhibitor comprises: directly mixing 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

### Embodiment 16

The cell protection solution in the reagent bottle 14 mentioned in embodiment 1 is mainly formed by dissolving mycoplasma inhibitor, gentamicin, hydroxyethyl starch, chitin, dextran, heparin sodium, sodium selenite, N-Acetyl-L-cysteine, lactobionic acid, blood albumin, sodium gluconate, glucosamine, cefoperazone sodium and phenol sulfonphthalein with a MEM-α medium aqueous solution, wherein each mL of the MEM-α medium aqueous solution dissolves 10 mg of the mycoplasma inhibitor, 180 U of the gentamicin, 8 mg of the hydroxyethyl starch, 3 mg of the chitin, 6 mg of the dextran, 3 mg of the heparin sodium, 0.4 mg of the sodium selenite, 0.1 mg of the N-Acetyl-L-cysteine, 8 mg of the lactobionic acid, 4 mg of the blood albumin, 8 mg of the sodium gluconate, 6 mg of the glucosamine, 1 mg of the cefoperazone sodium and 1 mg of the phenol sulfonphthalein respectively, and the concentration of the MEM-α medium aqueous solution is 10 mg/mL.

The mycoplasma inhibitor includes components of the following part by weight: 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

The preparation method for the protection solution provided by this embodiment comprises: respectively dissolving 10 mg of the mycoplasma inhibitor, 180 U of the gentamicin, 8 mg of the hydroxyethyl starch, 3 mg of the chitin, 6 mg of the dextran, 3 mg of the heparin sodium, 0.4 mg of the sodium selenite, 0.1 mg of the N-Acetyl-L-cysteine, 8 mg of the lactobionic acid, 4 mg of the blood albumin, 8 mg of the sodium gluconate, 6 mg of the glucosamine, 1 mg of the cefoperazone sodium and 1 mg of the phenol sulfonphthalein in the MEM-α medium aqueous solution.

The preparation method for the mycoplasma inhibitor comprises: directly mixing 40 parts by weight of kitasamycin, 30 parts by weight of lymecycline, 50 parts by weight of gemifioxacin, 5 parts by weight of curcuma zedoaria extract, 4 parts by weight of houttuynia cordata extract and 3 parts by weight of rhizoma smilacis glabrae extract.

### Embodiment 17

The cell protection solution in the reagent bottle 14 mentioned in embodiment 1 is mainly formed by dissolving mycoplasma inhibitor, gentamicin, hydroxyethyl starch, chitin, dextran, heparin sodium, sodium selenite, N-Acetyl-L-cysteine, lactobionic acid, blood albumin, sodium gluconate, glucosamine, cefoperazone sodium and phenol sulfonphthalein with a MEM-α medium aqueous solution, wherein each mL of the MEM-α medium aqueous solution dissolves 20 mg of the mycoplasma inhibitor, 210 U of the gentamicin, 9 mg of the hydroxyethyl starch, 4 mg of the chitin, 4 mg of the dextran, 1 mg of the heparin sodium, 0.6 mg of the sodium selenite, 0.3 mg of the N-Acetyl-L-cysteine, 5 mg of the lactobionic acid, 2 mg of the blood albumin, 5 mg of the sodium gluconate, 4 mg of the glucosamine, 4 mg of the cefoperazone sodium and 3 mg of the phenol sulfonphthalein respectively, and the concentration of the MEM-α medium aqueous solution is 10 mg/mL.

The mycoplasma inhibitor includes components of the following part by weight: 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

The preparation method for the protection solution provided by this embodiment comprises: respectively dissolving 20 mg of the mycoplasma inhibitor, 210 U of the gentamicin, 9 mg of the hydroxyethyl starch, 4 mg of the chitin, 4 mg of the dextran, 1 mg of the heparin sodium, 0.6 mg of the sodium selenite, 0.3 mg of the N-Acetyl-L-cysteine, 5 mg of the lactobionic acid, 2 mg of the blood albumin, 5 mg of the sodium gluconate, 4 mg of the glucosamine, 4 mg of the cefoperazone sodium and 3 mg of the phenol sulfonphthalein in the MEM-α medium aqueous solution.

The preparation method for the mycoplasma inhibitor comprises: directly mixing 30 parts by weight of kitasamycin, 20 parts by weight of lymecycline, 35 parts by weight of gemifioxacin, 8 parts by weight of curcuma zedoaria extract, 6 parts by weight of houttuynia cordata extract and 5 parts by weight of rhizoma smilacis glabrae extract.

### Control Example 1

Control example 1 of the present invention provides a protection solution of placenta and umbilical cord cells. The protection solution is mainly formed by dissolving gentamicin with a MEM-α medium aqueous solution, wherein each mL of MEM-α medium aqueous solution dissolves 100 U of the gentamicin, and the concentration of the MEM-α medium aqueous solution is 10 mg/mL.

### Control Example 2

Control example 2 of the present invention provides a protection solution of placenta and umbilical cord cells. The protection solution is mainly formed by dissolving mycoplasma inhibitor with a MEM-α medium aqueous solution, wherein each mL of MEM-a medium aqueous solution dissolves 20 mg of the mycoplasma inhibitor, and the concentration of the MEM-α medium aqueous solution is 10 mg/mL.

The mycoplasma inhibitor includes components of the following part by weight: 15 parts by weight of kitasamycin.

### Control Example 3

Control example 3 of the present invention provides a protection solution of placenta and umbilical cord cells. The protection solution is mainly formed by dissolving mycoplasma inhibitor and gentamicin with a MEM-α medium aqueous solution, wherein each mL of MEM-α medium aqueous solution dissolves 20 mg of the mycoplasma inhibitor and 180 U of the gentamicin respectively, and the concentration of the MEM-α medium aqueous solution is 10 mg/mL.

The mycoplasma inhibitor includes components of the following part by weight: 30 parts by weight of lymecycline, 5 parts by weight of curcuma zedoaria extract and 3 parts by weight of rhizoma smilacis glabrae extract.

### Control Example 4

Control example 4 of the present invention provides a protection solution of placenta and umbilical cord cells. The protection solution is mainly formed by dissolving mycoplasma inhibitor, gentamicin and hydroxyethyl starch with a MEM-α medium aqueous solution, wherein each mL of MEM-α medium aqueous solution dissolves 20 mg of the mycoplasma inhibitor, 180 U of the gentamicin and 10 mg of the hydroxyethyl starch respectively, and the concentration of the MEM-α medium aqueous solution is 12.5 mg/mL.

The mycoplasma inhibitor includes components of the following part by weight: 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

### Control Example 5

Control example 5 of the present invention provides a protection solution of placenta and umbilical cord cells. The protection solution is mainly formed by dissolving mycoplasma inhibitor, gentamicin, hydroxyethyl starch, chitin and dextran with a MEM-α medium aqueous solution, wherein each mL of MEM-α medium aqueous solution dissolves 20 mg of the mycoplasma inhibitor, 180 U of the gentamicin, 9 mg of the hydroxyethyl starch, 1 mg of the chitin and 4 mg of the dextran respectively, and the concentration of the MEM-α medium aqueous solution is 12.5 mg/mL.

The mycoplasma inhibitor includes components of the following part by weight: 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

### Control Example 6

Control example 5 of the present invention provides a protection solution of placenta and umbilical cord cells. The protection solution is mainly formed by dissolving mycoplasma inhibitor, gentamicin, hydroxyethyl starch, chitin, dextran, heparin sodium and sodium selenite with a MEM-α medium aqueous solution, wherein each mL of the MEM-α medium aqueous solution dissolves 20 mg of the mycoplasma inhibitor, 180 U of the gentamicin, 9 mg of the hydroxyethyl starch, 4 mg of the chitin, 4 mg of the dextran, 3 mg of the heparin sodium and 0.4 mg of the sodium selenite respectively, and the concentration of the MEM-α medium aqueous solution is 14 mg/mL.

The mycoplasma inhibitor includes components of the following part by weight: 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

### Control Example 7

Control example 6 of the present invention provides a protection solution of placenta and umbilical cord cells. The protection solution is mainly formed by dissolving mycoplasma inhibitor, gentamicin, hydroxyethyl starch, chitin, dextran, heparin sodium, sodium selenite, N-Acetyl-L-cysteine, lactobionic acid and blood albumin with a MEM-α medium aqueous solution, wherein each mL of the MEM-α medium aqueous solution dissolves 20 mg of the mycoplasma inhibitor, 180 U of the gentamicin, 9 mg of the hydroxyethyl starch, 5 mg of the chitin, 4 mg of the dextran, 3 mg of the heparin sodium, 0.4 mg of the sodium selenite, 0.3 mg of the N-Acetyl-L-cysteine, 5 mg of the lactobionic acid and 2 mg of the blood albumin respectively, and the concentration of the MEM-α medium aqueous solution is 14 mg/mL.

The mycoplasma inhibitor includes components of the following part by weight: 20 parts by weight of kitasamycin, 10 parts by weight of lymecycline, 20 parts by weight of gemifioxacin, 10 parts by weight of curcuma zedoaria extract, 8 parts by weight of houttuynia cordata extract and 6 parts by weight of rhizoma smilacis glabrae extract.

Test 1. Influence of Protection Solution Provided by the Present Invention on Survival Rate of Placental Stem Cells and Mesenchymal Stem Cells

1. Testing Sample:

Testing protection solutions provided by embodiments 5 and 6 of the present invention and control example 1.

2. Collecting Sample:

Respectively collecting three groups of cell mass, the first group of cell mass including 1.9×10⁵ in-vitro placental stem cells and mesenchymal stem cells, the second group of cell mass including 2.5×10⁵ in-vitro placental stem cells and mesenchymal stem cells, the third group of cell mass including 2.2×10⁵ in-vitro placental stem cells and mesenchymal stem cells, respectively immersing the first group of cell mass, the second group of cell mass and the third group of cell mass in the protection solutions provided in embodiments 5 and 6 and control example 7, storing same for three days at the temperature of 4° C., and testing the number and growth situation of placental stem cells and mesenchymal stem cells in different protection solutions.

| | Number of | Number of | Survival rate |
|---|---|---|---|
| Group | primitive cells | stored cells | of cells |
| Embodiment 1 | 1.9 × 105 | 1.69 × 105 | 89% |
| Embodiment 2 | 2.5 × 105 | 2.37 × 105 | 95% |
| Control example 1 | 2.2 × 105 | 1.4 × 105 | 64% |

It can be known from the above-mentioned data that when the protection solution provided in examples 5 and 6 of the present invention is compared with that in control example 1, the protection solution provided in examples 5 and 6 of the present invention can effectively increase the survival rate of cells, and the higher the content of mycoplasma inhibitor and gentamicin in the protection solution is, the higher the survival rate of cells is, and the survival rate of cells in the protection solution provided in example 6 reaches 95%. Therefore, it can be proved that by adding mycoplasma inhibitor and aminoglycoside antibiotics in the MEM-α medium aqueous solution, the protection solution provided by the present invention can effectively simulate the human environment, increase the survival rate of cells, reduce apoptosis of cells, and prolong transportation time of cells. Moreover, the effect of the mixed aminoglycoside antibiotics added in embodiment 6 is obviously better than single aminoglycoside antibiotics.

Test 2. Test of Protection Solution Provided by the Present Invention on Activity Rate of Placental Stem Cells and Mesenchymal Stem Cells

1. Testing sample: taking the protection solution provided by embodiments 5, 11, 13 and 15 as experimental groups 1-4, and the protection solution provided by control examples 1, 4, 5 and 7 as control groups 1-4.

2. Collecting sample: respectively immersing the collected umbilical cord cells or placenta cells of the same number in experimental groups 1-4 and control groups 1-4.

Making umbilical cord cells or placenta cells of each experimental group and control group enter test procedure at 24 h, 48 h, 96 h, 240 h, 480 h, 960 h and 1920 h respectively, and adjusting the density of umbilical cord cells or placenta cells to be 1×10⁶ cells/mL; fully mixing according to cell suspension: 0.4% trypan blue=3:1 (v:v), measuring 20 μL of cell suspension and adding same into a cell counting chamber, and testing the activity rate of cells using a Countstar cell counter. Results of activity rate of cells are shown in the Table.

Results of activity rate of experimental groups and control groups

| | Activity rate of cells (%) | | | | | | |
|---|---|---|---|---|---|---|---|
| | 24 | 48 | 96 | 240 | 480 | 960 | 1920 |
| Group | h | h | h | h | h | h | h |
| Embodiment 1 | 82.3 | 68.2 | 55.3 | — | — | | |
| Embodiment 7 | 85.8 | 82.6 | 70.1 | 54.3 | — | | |
| Embodiment 9 | 90.9 | 86.7 | 80.8 | 68.5 | 55.5 | | |
| Embodiment 11 | 96.6 | 90.5 | 85.5 | 78.5 | 70.6 | 64.8 | 58.4 |
| Control example 1 | 56.3 | 35.5 | — | — | — | — | — |
| Control example 4 | 84.1 | 70.5 | 56.2 | — | — | — | — |
| Control example 5 | 87.7 | 84.2 | 75.2 | 60.1 | — | — | — |
| Control example 7 | 91.2 | 88.3 | 82.6.0 | 70.4 | 60.4 | — | — |
| Conventional cell | 60.6 | 30.2 | — | — | — | — | — |
| protection | | | | | | | |
| solution | | | | | | | |

Note:
“—” represents no activity.

It can be known from the above data that the cell activity of the placental stem cells and mesenchymal stem cells preserved by the protection solution provided by embodiment 5 is higher than that of the placental stem cells and mesenchymal stem cells preserved by the protection solution provided by control example 1; the activity of the placental stem cells and mesenchymal stem cells preserved by the protection solution provided by embodiments 11, 13 and 15 is higher than that of the placental stem cells and mesenchymal stem cells preserved by the protection solution provided by control examples 1, 4, 5 and 7; and the time of the placental stem cells and mesenchymal stem cells preserved by the protection solution provided by embodiments 13 and 15 is longer than the time of placental stem cells and mesenchymal stem cells preserved by the protection solution provided by control examples 5 and 7, that is, 480 h and 1920 h respectively.

It can be concluded that after the protection solution provided by the present invention lacks mycoplasma inhibitor or aminoglycoside antibiotics, the activity rate of stem cells is obviously reduced. In the protection solution, after hydroxyethyl starch and chitin are added into selected the MEM-α medium solution, the activity rate of placental stem cells and mesenchymal stem cells preserved by the protection solution can be obviously increased, and after one of hydroxyethyl starch and chitin is absent or replaced, the role of increasing the activity rate of stem cells is lost; moreover, by adding a mixture of dextran and heparin sodium into the protection solution, the preservation time of the placental stem cells and the mesenchymal stem cells can be increased, and the preservation time can be increased to 480 h, after one of dextran and heparin sodium is absent or replaced by other ingredient, the preservation time of the placental stem cells and the mesenchymal stem cells can be shortened; in the protection solution provided by the present invention, by adding a mixture of lactobionic acid, blood albumin, sodium gluconate and glucosamine into the protection solution, the preservation time of the placental stem cells and the mesenchymal stem cells can be increased, and the preservation time can be increased to 1920 h, and the activity rate of cells can be maintained above 65%.

Test 3. Influence of Protection Solution Provided by the Present Invention on Immunity of Placental Stem Cells and Mesenchymal Stem Cells

1. Testing Sample:

Testing protection solutions provided by embodiments 7, 9, and 14 of the present invention and control examples 2, 3 and 6.

2. Collecting Sample:

Respectively collecting six groups of cell mass, the first group of cell mass including 7.9×10⁵ in-vitro placental stem cells and mesenchymal stem cells, the second group of cell mass including 3.2×10⁵ in-vitro placental stem cells and mesenchymal stem cells, the third group of cell mass including 4.9×10⁵ in-vitro placental stem cells and mesenchymal stem cells, the fourth group of cell mass including 3.5×10⁵ in-vitro placental stem cells and mesenchymal stem cells, the fifth group of cell mass including 4.2×10⁵ in-vitro placental stem cells and mesenchymal stem cells, the sixth group of cell mass including 3.2×10⁵ in-vitro placental stem cells and mesenchymal stem cells, respectively immersing the first group of cell mass, the second group of cell mass, the third group of cell mass, the fourth group of cell mass, the fifth group of cell mass and the sixth group of cell mass in the protection solutions provided by embodiments 7, 9 and 14 and control examples 2, 3 and 6, storing same for twelve days at the temperature of 4° C., digestively treating the cultured placental stem cells and mesenchymal stem cells and then counting and testing the number of cells infected with mycoplasma or other bacteria using a flow cytometer, and calculating the infection rate of cells infected with mycoplasma or bacteria. Results are shown in the following Table:

| | Total number | Number of | Infection |
|---|---|---|---|
| Group | of cells | uninfected cells | rate |
| Embodiment 7 | 7.9 × 105 | 5.7 × 105 | 28% |
| Embodiment 9 | 3.2 × 105 | 2.72 × 105 | 15% |
| Embodiment 14 | 4.9 × 105 | 4.61 × 105 | 6% |
| Control example 2 | 3.5 × 105 | 2.1 × 105 | 40% |
| Control example 3 | 4.2 × 105 | 3.15 × 105 | 25% |
| Control example 6 | 3.2 × 105 | 2.82 × 105 | 12% |

It can be concluded from the above-mentioned data and it can be known from embodiment 7 and control example 2 that gentamicin and mycoplasma inhibitor included in the protection solution provided by the present invention can effectively inhibit the generation of bacteria or mycoplasma and can kill mycoplasma at the same time, and it is confirmed that no one ingredient can achieve the effect of inhibiting bacteria or mycoplasma. It can be known from embodiment 9 and control example 3 that the mycoplasma inhibitor formed by integrating traditional Chinese and Western medicine can effectively reduce the formation of mycoplasma and bacteria, and the mycoplasma inhibitor including kitasamycin, lymecycline, gemifioxacin, curcuma zedoaria extract, houttuynia cordata extract and rhizoma smilacis glabrae extract disclosed by the present invention can effectively inhibit and kill mycoplasma; and it can be known from embodiment 14 and control example 6 that the protection solution provided by the present invention can effectively increase the immunity of cells, preventing cells from being infected by mycoplasma.

The cell protection solution of placenta or umbilical cord of the present invention is used to preserve umbilical cord or placenta from human beings during the time after placenta or umbilical cord is collected to the time before umbilical cord or placenta is separated. The cell protection solution of placenta or umbilical cord of the present invention can reduce metabolism of placenta or umbilical cord in the process of preserving placenta or umbilical cord, can reduce accumulation of metabolites, can provide some basic nutrient substances and energy substances to maintain the lowest metabolic level, and can effectively preserve the activity of stem cells in placenta or umbilical cord, greatly reducing the limitation of time of transportation, handing over and test. For the placenta or umbilical cord preserved by this protection solution, time has little influence on the activity of separated stem cells, reducing the limitation of time from collection to preparation of placenta or umbilical cord, and all the ingredients used are in conformity with clinical standards, so that the pollution rate is low. For the placenta or umbilical cord preserved at the constant temperature of 2-10° C. by this protection solution, the activity of cells in the placenta or umbilical cord preserved for 48 h is 80% that of the collected fresh placenta or umbilical cord, and compared with the preserved placenta or umbilical cord not added with any solution, the pollution rate of the collected preserved placenta or umbilical cord is reduced to 0.15% from 1.2%.

The above embodiments do not limit the present invention. Anyone should know that for products of other various forms, regardless of any change in shape or structure, the technical solutions identical or similar to that of the present application made under the enlightenment of the present invention shall fall in the protection scope of the present invention.

1. A kit for collection of umbilical cord, umbilical cord blood and placenta, comprising:
a collection case; and
a case cover hinged with the collection case;
wherein a tool box, a freezing box and a refrigeration box are arranged in the collection case from top to bottom in sequence,
wherein both the refrigeration box and the freezing box are slidably connected with the collection box;
a liner plate arranged in the tool box, the liner plate is provided with an accommodating trough, three storage troughs and several test tube troughs, at least three vacuum blood collection tubes are arranged in the accommodating trough, and a umbilical cord collection box, a placenta collection box and a blood collection bag are respectively arranged in the three storage troughs;
a reagent bottle for containing a cell protection solution is arranged in the refrigeration box; and
several ice bags are arranged in the freezing box.

2. The kit for collection of umbilical cord, umbilical cord blood and placenta of claim 1, further comprising:
a rotating frame arranged in the refrigeration box, the rotating frame comprising a bottom plate, a storage box and a rotating drum fixed onto the bottom plate,
wherein the middle of the storage box is provided with a through hole,
wherein the storage box is sleeved on the rotating drum through the through hole,
wherein the storage box is internally divided into a plurality of sub boxes by baffle plates,
wherein the reagent bottle is placed in one of the sub boxes,
wherein the rotating drum is of a hollow structure,
wherein the ice bags are arranged in the rotating drum, and
wherein the side wall of the rotating drum is provided with several through holes.

3. The kit for collection of umbilical cord, umbilical cord blood and placenta of claim 1,
wherein an inner wall of the refrigeration box is uniformly provided with several grooves for placing the ice bags.

4. The kit for collection of umbilical cord, umbilical cord blood and placenta of claim 1, further comprising:
a temperature control device being comprised of a controller, an alarm, a display screen and a temperature sensor arranged in the refrigeration box,
wherein the controller, the alarm and the display screen are all arranged on the case cover, and
wherein the alarm, the display screen and the temperature sensor are all connected with the controller.

5. The kit for collection of umbilical cord, umbilical cord blood and placenta of claim 2,
wherein each of the umbilical cord collection box and the placenta collection box comprises a box body and a box cover adapted to the box body,
wherein a magnet is arranged at the bottom of the box body,
wherein a magnetic object attracted to the magnet is arranged at the inner bottom of the sub box, the magnetic object being a magnet or a metal block, and
wherein the box body is provided with a bar code slot.

6. The kit for collection of umbilical cord, umbilical cord blood and placenta of claim 1, further comprising:
a containing box arranged at one side of the collection case, and record specifications, collection cards and bar codes placed in the containing box.

7. The kit for collection of umbilical cord, umbilical cord blood and placenta of claim 1, wherein the liner plate is comprised of elastic material, the elastic material being comprised of components of the following part by weight: 30-45 parts by weight of basalt fiber, 10-25 parts by weight of aliphatic petroleum resin, 5-18 parts by weight of stannous octoate, 20-25 parts by weight of sodium tripolyphosphate and 10-15 parts by weight of C-12 alcohol ester.

8. The kit for collection of umbilical cord, umbilical cord blood and placenta of claim 1, wherein the cell protection solution in the reagent bottle is mainly formed by dissolving mycoplasma inhibitor and aminoglycoside antibiotics with a MEM-α medium aqueous solution, wherein each mL of the MEM-α medium aqueous solution dissolves 10-30 mg of the mycoplasma inhibitor and 180-240 U of the aminoglycoside antibiotics respectively, and the concentration of the MEM-α medium aqueous solution is 10-15 mg/m L; preferably, the aminoglycoside antibiotics is one or more of gentamicin, kanamycin, amikacin and tobramycin.

9. The kit for collection of umbilical cord, umbilical cord blood and placenta of claim 8, wherein the mycoplasma inhibitor comprises components of the following part by weight: 20-40 parts by weight of kitasamycin, 10-30 parts by weight of lymecycline and 20-50 parts by weight of gemifioxacin;
wherein the mycoplasma inhibitor further comprises components of the following part by weight: 5-10 parts by weight of curcuma zedoaria extract, 4-8 parts by weight of houttuynia cordata extract and 3-6 parts by weight of rhizoma smilacis glabrae extract.

10. The kit for collection of umbilical cord, umbilical cord blood and placenta of claim 8, wherein the protection solution further comprises lactobionic acid, blood albumin, sodium gluconate and glucosamine, wherein each mL of the MEM-α medium aqueous solution dissolves 5-8 mg of the lactobionic acid, 2-4 mg of the blood albumin, 5-8 mg of the sodium gluconate and 4-6 mg of the glucosamine respectively.
